(19) United States
(12) Patent Application Publication
(10) Pub. No.: US 2020/0268594 A1
(43) Pub. Date: Aug. 27, 2020

(54) MASSAGING HEAD FOR A MASSAGE DEVICE

(71) Applicant: Thomas F. Pepe, Bradenton, FL (US)

(72) Inventor: Thomas F. Pepe, Bradenton, FL (US)

(73) Assignee: TT Therapeutics, LLC, Missouri City, TX (US)

(21) Appl. No.: 16/802,539

(22) Filed: Feb. 26, 2020

Related U.S. Application Data
(60) Provisional application No. 62/810,414, filed on Feb. 26, 2019.

(51) Int. Cl. A61H 15/00; A61H 23/02

(52) U.S. Cl. CPC A61H 15/0085; A61H 23/0254; A61H 2201/0107; A61H 2201/0207; A61H 2201/0228; A61H 2015/0071

(57) ABSTRACT

A massage head for a massage device is disclosed. The massage head comprises a first hemispherical section and a second hemispherical section. The first hemispherical section is defining a central recess, configured to threadably receive a quick release member. The second hemispherical section is securely and detachably connected to the first hemispherical section, thereby making the massage head. The second hemispherical section comprises a heating element, configured to heat the second hemispherical section for providing additional therapeutic effect for a user while massaging body parts, thereby effectively relieving muscle soreness. The heating element is electrically connected to a power source by electrically connecting a plug connector to a plug-in receiver. The massage head is securely connected to a shaft of the massage device by connecting the quick release member to a coupling member, which is securely affixed to the shaft of the massage device.

### CROSS REFERENCE TO RELATED APPLICATION

The present application claims the benefit of U.S. Provisional Patent Application No. 62/810,414 for “Powered Shaft Tips for Massager Machine”, filed Feb. 26, 2019, the contents of which is hereby incorporated by reference.

### BACKGROUND OF THE INVENTION

### A. Technical Field

The present invention generally relates to a massage device. Specifically, the present invention relates to a massaging head for a massage device, configured to enable a user to simply and conveniently set up with minimal effort and function efficiently and reliably to massage any desired part of the user's body.

### B. Description of Related Art

Massage is the beneficial practice of tissue manipulation. By way of example, massage can provide therapeutic advantages, alleviate pain, stimulate circulation, relieve tension, provide flexibility to muscles and joints, and improve range of motion, and so forth. Additionally, massage can provide psychological benefits such as lessening depression and anxiety and increasing sleep quality.

Currently, people using different kind of massage devices and tools for massaging their bodies. However, the conventional massage devices and tools are manufactured and used in various forms according to the massage area. The conventional massage tools and devices are expensive, large, relatively heavy, and tethered to an electrical power source. Further, the conventional massage devices may require users to hold with both hands while using and are relatively noisy.

One such a prior art device is described in U.S. Pat. No. 10,357,425 to Jason Wersland et.al, discloses a massage device which provides an efficient and therapeutically beneficial treatment to the muscles targeted by the device. The device consists of a motor configured to rotate a shaft, the compliant shaft damper configured to absorb vibration and transmit rotary motion generated by the motor while deforming under vibration loads. The power source is a rechargeable battery which provides electrical current and attachable to the reciprocating treatment device, the attachment can be interchangeable and removable. The actuated output includes a threaded connector for connection of an attachment, and also includes a male connector on a distal end which comprise of outwardly biased ball bearing configured to mate with a treatment structure.

Another prior art CN2297192 assigned to X U Rongsen, discloses a detachable multipurpose therapeutic device for massaging human bodies, the motor chamber is provided with ccentric shaft of the motor, powered by a battery, and a projecting tip having a ball cartridge memory drug massage balls in the outer urface of the lower end of the grip boss. The lower end of the side grip is provided with a threaded post can be screwed to each other ball stud body is provided with a hole pharmaceutically sphere. The pivot hole and the pivot shaft connected with the massage ball feature s a battery. The massage heads removably held in the hand. The tip or small point can be used in deeper parts of the pressure sensitive means massage balls cartridge provides a pharmaceutical infiltration massage. However, the mentioned prior art devices are limited in ability to adjust to the various contours of a person's anatomy, for example, the neck, shoulders, arms and legs, thereby limiting the point of contact of the massage to a pre-set spacing.

Accordingly, there is a need for a massaging head for a massager used to simply and conveniently apply massage on any desired part of the user's body. Further, there is also a need for a massaging head for a massager which is extremely stable in operation, inexpensive, simple to set up with minimal effort, small in size, functions efficiently and reliably to massage any desired part of the user's body.

### SUMMARY OF THE INVENTION

The present invention generally discloses a massage device. The present invention directed to a massaging head for a massage device, configured to enable a user to simply and conveniently set up with minimal effort and function efficiently and reliably to massage any desired part of the user's body.

In one embodiment, the massage head is configured to enable a user to detachably connect to the massage device. In one embodiment, the massage head is further configured to enable the user to massage any part of the body. In one embodiment, the massage head is secured to the massage device by threadably connecting to a shaft. In one embodiment, the massage head could be used to provide a massaging effect simultaneously with either a therapeutic warming or cooling effect and/or any other therapeutic related service, depending upon the need of the user for any specific type of massage.

In one embodiment, the massage head comprises a first hemispherical section and a second hemispherical section. In one embodiment, the first hemispherical section defining a central recess (shown configured to threadably receive a quick release member. In one embodiment, the second hemispherical section is securely and detachably connected to the first hemispherical section, thereby making the massage head. In one embodiment, the massage head is securely and threadably connected to the shaft of the massage device using a quick release member and a coupling member. In one embodiment, the massage head further comprises a vibration generator. In one embodiment, the vibration generator is securely and operatively disposed at the bottom portion of the second hemispherical section. The vibration generator is configured to vibrate the massage head, thereby enabling the user to effectively massage the body parts.

In one embodiment, the massage head further comprises at least one heating element. In one embodiment, the heating element is securely disposed at a bottom portion of the second hemispherical section. In one embodiment, the heating element is configured to heat the second hemispherical section for providing additional therapeutic effect for the user while massaging body parts, thereby effectively relieving muscle soreness. In one embodiment, the heating element is electrically connected to a power source by electrically connecting a plug connector to a plug-in receiver. In one embodiment, the heating element is electrically connected to the plug connector using one or more electrical conductors, for example, wires. In one embodiment, the plug connector is extended forwardly outward via the central recess of the first hemispherical section and via an opening of the quick release member.

In one embodiment, the quick release member comprises an opening at a center for allowing the plug connector forwardly outward and at least two locking projections on both sides at a top portion. In one embodiment, the two locking projections are configured to lock and secure the massage head to the shaft of the massage device. In one embodiment, the coupling member is configured to securely affix to the shaft of the massage device. The massage head is securely connected to the shaft of the by connecting the quick release member to the coupling member. In one embodiment, the coupling member comprises at least two slots for receiving the locking projections of the quick release member, thereby enabling the user to detachably secure the massage head to the massage device. In one embodiment, the coupling member further comprises an opening, in which the plug-in receiver is extended forwardly outward, thereby enabling the user to connect the plug connector to the plug-in receiver for supplying electrical power. The plug-in receiver is electrically connected to a power source via a cable within the massage device.

In one embodiment, the massage head further comprises a power switch. In one embodiment, the power switch is configured to enable the user to turn on and turn off the heating element. In one embodiment, the massage head further comprises a power source, for example, a battery. The power source could supply power to the massage head. In one embodiment, the massage head further comprises at least universal serial bus (USB) port. In one embodiment, the USB port is configured to enable the user to recharge the power source, for example, a battery using a cable and an adapter). In one embodiment, the vibration generator is securely and operatively disposed at the bottom portion of the second hemispherical section. The vibration generator is configured to vibrate the massage head, thereby enabling the user to effectively massage the body parts. In one embodiment, the massage head further comprises a threaded wall at the center portion for allowing the user to threadably connect the massage head to the shaft using at least one coupling member, for example, a threaded member.

In one embodiment, the massage head is securely and threadably connected to the shaft using the threaded fastener. In one embodiment, the threaded fastener is securely affixed to the one end of the shaft. In one embodiment, the threaded fastener could enable the massage device to connect any other massage heads via threading means.

In one embodiment, the adapter is configured to enable the user to connect to the power supply and to a charging port of the massage device for recharging the battery, which is securely disposed within the massage device. In another embodiment, the adapter is configured to enable the user to connect to the power supply and to the massage device for powering electrical components, for example, a motor, within the massage device.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The embodiments herein will be better understood from the following detailed description with reference to the drawings, in which:

FIG. 1 shows a side view of a massage head detachably connected to a massage device in an embodiment of the present invention.

FIG. 2 shows a front view of a massage head detachably connected to a massage device in an embodiment of the present invention.

FIG. 3 shows a side view of a massage head detachably connected to a massage device in one embodiment of the present invention.

FIG. 4 shows a front view of a massage head detachably connected to a massage device in one embodiment of the present invention.

FIG. 5 shows a perspective view of the massage head in one embodiment of the present invention.

FIG. 6 shows a sectional view of the massage head in one embodiment of the present invention.

FIG. 7 shows a top view of a heating element electrically connected to the plug connector in one embodiment of the present invention.

FIG. 8 shows a perspective view of a plug connector extended forwardly outward via a quick release member in one embodiment of the present invention.

FIG. 9 shows a perspective view of a quick release member in one embodiment of the present invention.

FIG. 10 shows a top perspective view of a coupling member in one embodiment of the present invention.

FIG. 11 shows a top perspective view of the massage head in one embodiment of the present invention.

FIG. 12 shows a perspective view of the massage head threadably connected to a shaft of the massage device using a threaded fastener in one embodiment of the present invention.

FIG. 13 shows an exploded view of the massage device in one embodiment of the present invention.

FIG. 14 shows a perspective view of a threaded fastener in one embodiment of the present invention.

FIG. 15 shows a perspective view of a threaded fastener in another embodiment of the present invention.

FIG. 16 shows a perspective view of an adapter for charging the massage device in one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

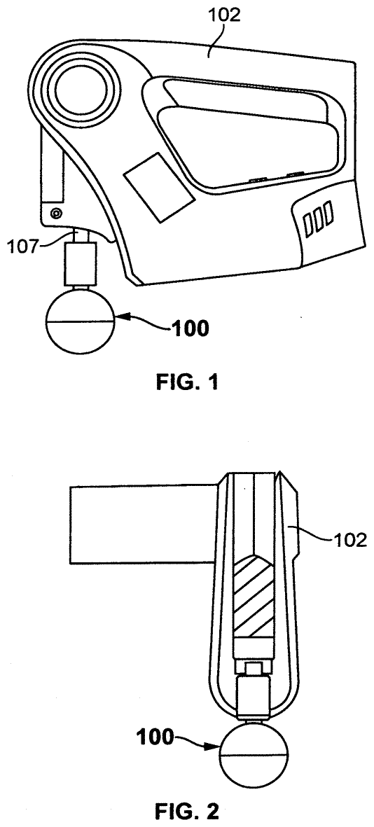

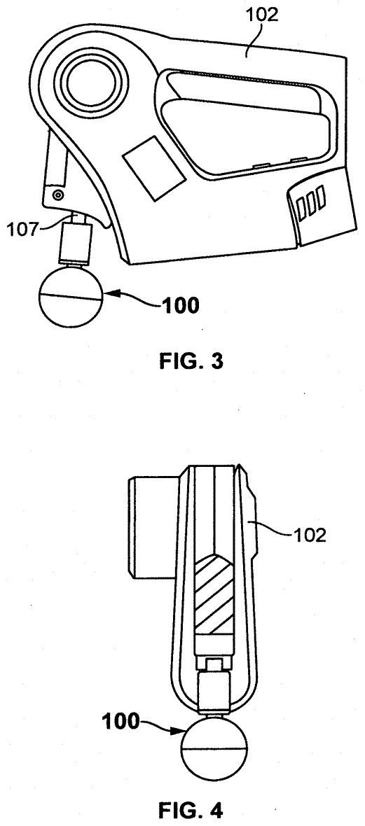

Referring to FIGS. 1-2, a massage head 100 detachably connected to a massager or massage device 102 is disclosed. In one embodiment, the massage head 100 is configured to enable a user to detachably connect to the massage device 102. In one embodiment, the massage head 100 is further configured to enable the user to massage any part of the body. In one embodiment, the massage head 100 is secured to the massage device 102 by threadably connecting to a shaft 107. In one embodiment, the massage device 102 has a length of about, but not limited to, 184.75″ and a height of about, but not limited to, 147.03″. In one embodiment, the massage device 102 has a width of about, but not limited to, 129.25″. In one embodiment, the massage head 100 could be used to provide a massaging effect simultaneously with either a therapeutic warming or cooling effect and/or any other therapeutic related service, depending upon the need of the user for any specific type of massage.

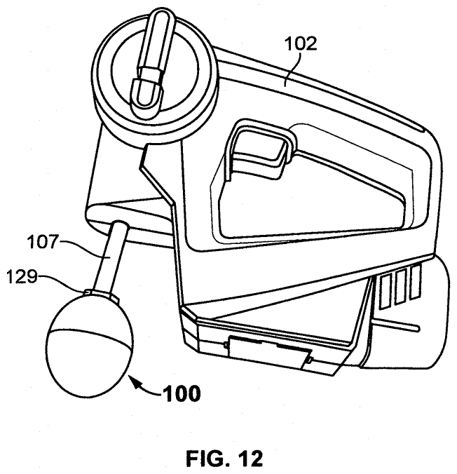

Referring to FIGS. 3-4, the massage head 100 detachably connected to a massager or massage device 102 is disclosed. In one embodiment, the massage device 102 has a length of about, but not limited to, 192.25″ and a height of about, but not limited to, 155.39″. In one embodiment, the massage device 102 has a width of about, but not limited to, 74.34″. In one embodiment, the massage device 102 could be powered by a power source 160 (shown in FIG. 11), for example, a battery. In one embodiment, the massage device 102 is configured to allow the users to operate in different modes of operations. The shaft 107 that the attachments will screw into will be made of a metal, for example, titanium. In one embodiment, the shaft 107 could be threaded to threaded to accept other types of massage heads such as non-powered massage heads.

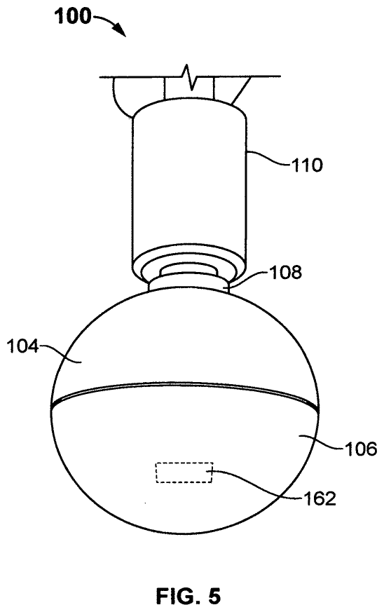

Referring to FIG. 5, the massage head 100 of the invention is disclosed. In one embodiment, the massage head 100 comprises a first hemispherical section 104 and a second hemispherical section 106. In one embodiment, the first hemispherical section 104 defining a central recess 105 (shown in FIG. 12), configured to threadably receive a quick release member 108. In one embodiment, the second hemispherical section 106 is securely and detachably connected to the first hemispherical section 104, thereby making the massage head 100. In one embodiment, the massage head 100 is securely and threadably connected to the shaft 107 of the massage device 102 using a quick release member 108 and a coupling member 110. In one embodiment, the massage head 100 further comprises a vibration generator 162. In one embodiment, the vibration generator 162 is securely and operatively disposed at the bottom portion of the second hemispherical section 106. The vibration generator 162 is configured to vibrate the massage head 100, thereby enabling the user to effectively massage the body parts.

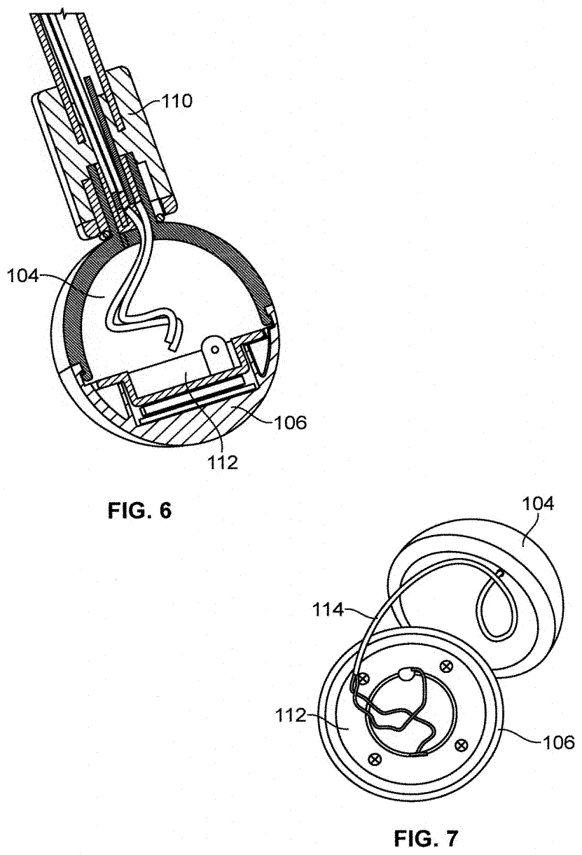

Referring to FIG. 6, a sectional view of the massage head 100 in one embodiment of the preset invention is disclosed. In one embodiment, the massage head 100 is further comprises at least one heating element 112. In one embodiment, the heating element 112 is securely disposed at a bottom portion of the second hemispherical section 106. In one embodiment, the heating element 112 is configured to heat the second hemispherical section 106 for providing additional therapeutic effect for the user while massaging body parts, thereby effectively relieving muscle soreness. In one embodiment, the heating element 112 is electrically connected to a power source by electrically connecting a plug connector 116 (shown in FIG. 7) to a plug-in receiver 120 (shown in FIG. 11).

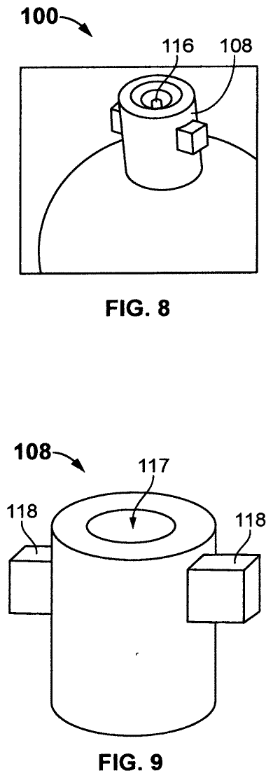

Referring to FIG. 7, the heating element 112 electrically connected to the plug connector 116 (shown in FIG. 8) is disclosed. In one embodiment, the heating element 112 is electrically connected to the plug connector 116 using one or more electrical conductors 114, for example, electrical wires. Referring to FIG. 8, the plug connector 116 extended forwardly outward via a quick release member 108 is disclosed. In one embodiment, the plug connector 116 is extended forwardly outward via the central recess 105 of the first hemispherical section 104 and via an opening 117 (shown in FIG. 9) of the quick release member 108.

Referring to FIG. 9, the quick release member 108 of the invention is disclosed. In one embodiment, the quick release member 108 comprises an opening 117 at a center for allowing the plug connector 116 (shown in FIG. 8) forwardly outward and at least two locking projections 118 on both sides at a top portion. In one embodiment, the two locking projections 118 are configured to lock and secure the massage head 100 to the shaft 107 (shown in FIG. 12) of the massage device 102.

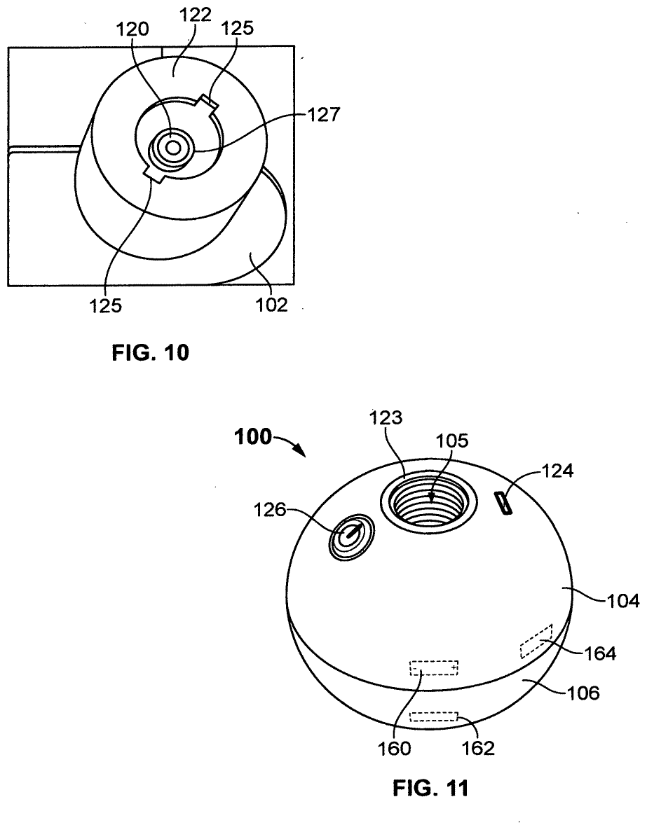

Referring to FIG. 10, a coupling member 122 of the invention is disclosed. In one embodiment, the coupling member 122 is configured to securely affix to the shaft 107 of the massage device 102. The massage head 100 is securely connected to the shaft 107 of the by connecting the quick release member 108 (shown in FIG. 9) to the coupling member 122. In one embodiment, the coupling member 122 comprises at least two slots 125 for receiving the locking projections 118 (shown in FIG. 9) of the quick release member 108, thereby enabling the user to detachably secure the massage head 100 to the massage device 102. In one embodiment, the coupling member 122 further comprises an opening 127, in which the plug-in receiver 120 is extended forwardly outward, thereby enabling the user to connect the plug connector 116 to the plug-in receiver 120 for supplying electrical power. The plug-in receiver 120 is electrically connected to a power source via a cable within the massage device.

Referring to FIG. 11, the massage head 100 of the present invention is disclosed. In one embodiment, the massage head 100 further comprises a power switch 126. In one embodiment, the power switch 126 is configured to enable the user to turn on and turn off the heating element 112. In one embodiment, the massage head 100 further comprises a power source 160, for example, a battery. The power source 160 could supply power to the massage head 100. In one embodiment, the massage head 100 is further comprises at least universal serial bus (USB) port 124. In one embodiment, the USB port 124 is configured to enable the user to recharge the power source 160, for example, a battery using a cable and an adapter 132 (shown in FIG. 16). In one embodiment, the vibration generator 162 is securely and operatively disposed at the bottom portion of the second hemispherical section 106. The vibration generator 162 is configured to vibrate the massage head 100, thereby enabling the user to effectively massage the body parts. In one embodiment, the massage head 100 further comprises a threaded wall 123 at the center portion for allowing the user to threadably connect the massage head 100 to the shaft 107 using at least one coupling member, for example, a threaded member.

Referring to FIG. 12, the massage head 100 securely connected to the shaft 107 using a threaded fastener 129 is disclosed. In one embodiment, the massage head 100 is securely and threadably connected to the shaft 107 using the threaded fastener 129. In one embodiment, the threaded fastener 129 is securely affixed to the one end of the shaft 107. In one embodiment, the threaded fastener 129 could enable the massage device 102 to connect any other massage heads via threading means.

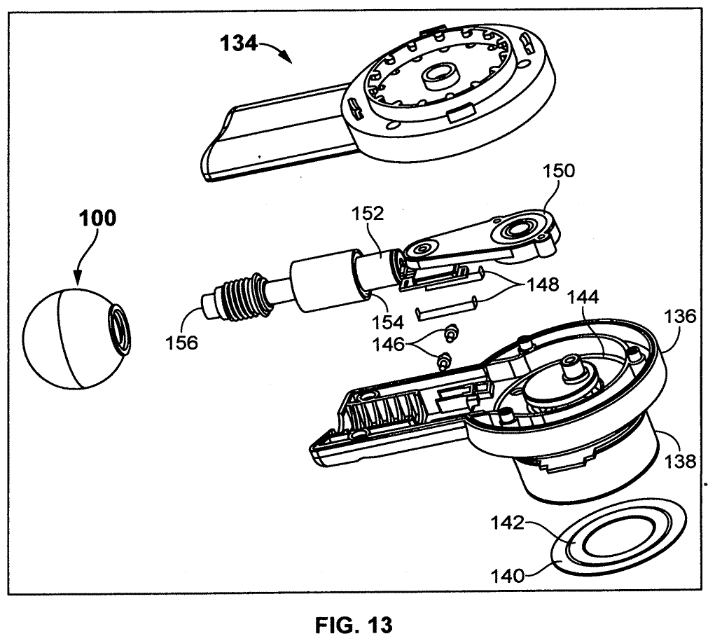

Referring to FIG. 13, the exploded view of the massage device 102 is disclosed. In one embodiment, the massage device 102 comprises an upper cover 134, a lower cover 136, at least one brushless motor 138, at least two conductive copper sheets (140 and 142), an eccentric block 144, at least two conductive bearings 146, at least two conductive coppers 148, a swing shift 150, a moving pole 152, a copper sleeve 154, and a DC conductive tip 156. In one embodiment, the at least two conductive copper sheets (140 and 142) are securely positioned into the lower cover 136. The conductive bearings 146 are positioned at the corresponding position of negative and positive terminals and then welded it with the copper sheets (140 and 142). After, the positive and negative wire of 12 V DC tips are welded on the corresponding position of the PCB copper sheet and check the DC conductive tip 156 to make sure for power supply. Further, the upper cover 134 is securely affixed to the lower cover 136 using one or more fasteners, for example, nuts and bolts. In one embodiment, the massage head 100 is electrically connected to the DC conductive tip 156 of the massage device 100.

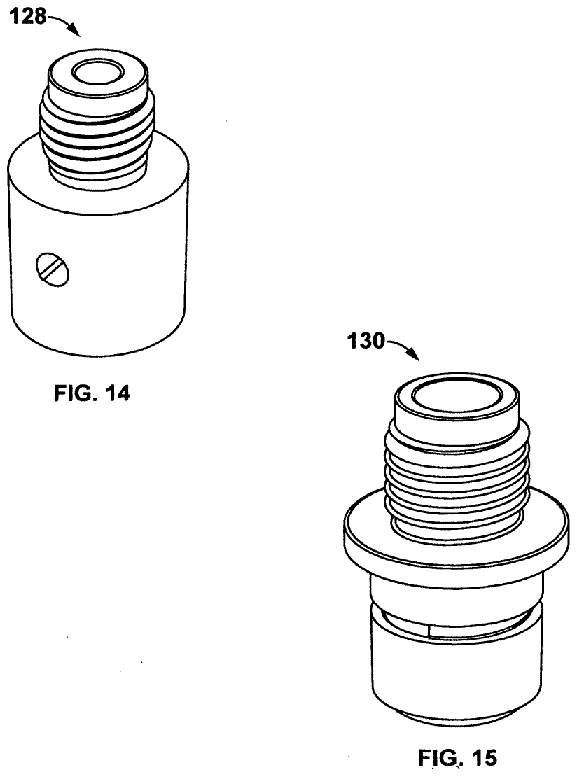

Referring to FIG. 14, a threaded fastener 128 of the present invention is disclosed. In one embodiment, the threaded fastener 128 is configured to enable the user to securely connect to the shaft 107 of the massage device 102 at one end using at least one or more fasteners, for example, a screw. In one embodiment, the user could threadably secure the massage head 100 to the shaft 107 at another end of the threaded fastener 128. In one embodiment, the threaded fastener 128 is made of a material, but not limited to, steel.

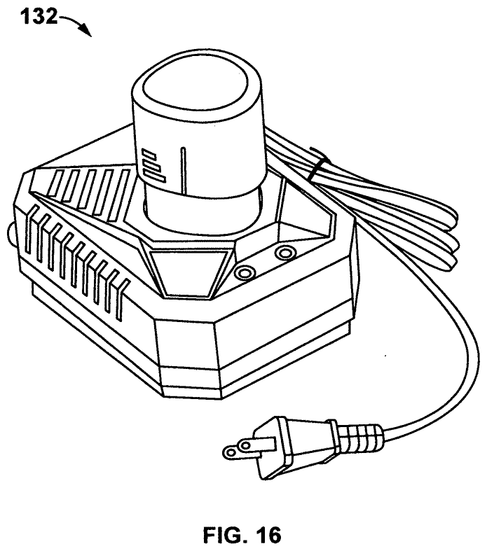

Referring to FIG. 15, a threaded fastener 130 of the present invention is disclosed. In another embodiment, the threaded fastener 130 is configured to enable the user to securely connect to the shaft 107 of the massage device 102 at one end using at least one or more fasteners, for example, a screw. In one embodiment, the user could threadably secure the massage head 100 to the shaft 107 at another end of the threaded fastener 130. In one embodiment, the threaded fastener 130 is made of a material, but not limited to, steel.

Referring to FIG. 16, the adapter 132 for charging the massage device 102 is disclosed. In one embodiment, the adapter 132 is configured to enable the user to connect to the power supply and to a charging port of the massage device 102 for recharging the battery, which is securely disposed within the massage device 102. In another embodiment, the adapter 132 is configured to enable the user to connect to the power supply and to the massage device 102 for powering electrical components, for example, a motor, within the massage device 102.

The advantages of the present invention include that the massage head 100 will be quickly and easily adjustable so as to enable the user to conveniently massage any part of the body. The user could simply and detachably connect the massage head 100 to the massage device 102 without any hesitation The massage head 100 is inexpensive in manufacture, simple to set up with minimal effort, small in size and readily transportable, and which could be used to provide a massaging effect simultaneously with either a therapeutic warming or cooling effect and/or any other therapeutic related service, depending upon the need of the user for any specific type of massage. The massage head 100 is safe to use, functions efficiently, and reliably to massage any desired part of the user's body.

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention.

The foregoing description comprises illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

1. A massage head for a massage device, comprising:
a first hemispherical section defining a central recess, wherein the central recess is configured to threadably receive a quick release member;
a second hemispherical section securely and detachably connected to the first hemispherical section, thereby making the massage head, wherein the second hemispherical section, comprising:
a heating element configured to heat the second hemispherical section for providing additional therapeutic effect for a user while massaging body parts, thereby effectively relieving muscle soreness;
wherein the heating element is electrically connected to a power source by electrically connecting a plug connector to a plug-in receiver.

2. The massage head of claim 1, is securely connected to a shaft of the massage device by connecting the quick release member to a coupling member, wherein the coupling member is securely affixed to the shaft of the massage device.

3. The massage head of claim 1, wherein the quick release member comprises an opening at a center for allowing the plug connector forwardly outward and at least two locking projections on both sides at a top portion.

4. The massage head of claim 1, wherein the coupling member comprises at least two slots for receiving the locking projections of the quick release member, thereby detachably securing the massage head to the massage device.

5. The massage head of claim 1, wherein the coupling member further comprises an opening at a center for allowing the plug-in receiver forwardly outward, thereby enabling the user to electrically connect the massage head to the massage device by connecting the plug connector to the plug-in receiver, wherein the plug-in receiver is electrically connected to a power source via a cable within the massage device.

6. The massage head of claim 1, wherein the heating element is securely disposed at a bottom portion of the second hemispherical section.

7. The massage head of claim 1, wherein the heating element is electrically connected to the plug connector using one or more electrical conductors.

8. The massage head of claim 1, further comprises a battery for supplying electrical power to the heating element, wherein the battery is securely disposed at a bottom portion of the second hemispherical section.

9. The massage head of claim 1, further comprises a power switch, wherein the power switch is configured to enable the user to turn on and turn off the heating element.

10. The massage head of claim 1, further comprises a universal serial bus (USB) port, wherein the USB port is configured to enable the user to recharge the battery using a cable and an adapter.

11. The massage head of claim 1, wherein the first hemispherical section is made of rigid plastic.

12. The massage head of claim 1, wherein the second hemispherical section is made of a material includes steel and rigid plastic.

13. The massage head of claim 1, further comprises a vibration generator, wherein the vibration generator is securely and operatively disposed at the bottom portion of the second hemispherical section.

14. The massage head of claim 1, wherein the vibration generator is configured to vibrate the massage head, thereby enabling the user to effectively massage the body parts.

15. The massage head of claim 1, is further configured to securely and threadably connected to the shaft of the massage device via a threaded fastener.

16. The massage head of claim 1, is further configured to wirelessly connect to a heart rate/temperature and location reading device with an alarm during use via a software application and a wireless communication network, wherein the wireless communication network is Bluetooth®.

17. The massage head of claim 1, further comprises a Bluetooth® module.
